(19) United States
(12) Patent Application Publication
(10) Pub. No.: US 2012/0008463 A1
(43) Pub. Date: Jan. 12, 2012

(54) HIGH DATA RATE ACOUSTIC MULTIPLE-INPUT/MULTIPLE-OUTPUT (MIMO) COMMUNICATION APPARATUS AND SYSTEM FOR SUBMERSIBLES

(75) Inventors: Mohsen Badiey, Newark, DE (US); Aijun Song, Bear, DE (US); Arthur C. Trembanis, Newark, DE (US)

(73) Assignee: University of Delaware, Newark, DE (US)

(21) Appl. No.: 13/089,838

(22) Filed: Apr. 19, 2011

Related U.S. Application Data
(60) Provisional application No. 61/325,618, filed on Apr. 19, 2010.
(60) Provisional application No. 61/352,056, filed on Jun. 7, 2010.

(51) Int. Cl. H04B 13/02

(52) U.S. Cl. 367/131

(57) ABSTRACT

Underwater multiple input/multiple output (MIMO) communication apparatus, systems, and methods are disclosed. An underwater MIMO apparatus includes a submersible housing having a water impermeable section, a data acquisition system located within the water impermeable section of the submersible housing, and at least two transmission communication elements electrically connected to the data acquisition system. The MIMO communication apparatus may be used in a communication system including a communication array for communicating with the MIMO communication apparatus using a MIMO communication method.

### CROSS REFERENCE TO RELATED APPLICATIONS

This application claims priority to U.S. Provisional Application Ser. No. 61/325,618, entitled “A MOBILE ACOUSTIC MULTIPLE-INPUT/MULTIPLE-OUTPUT (MIMO) COMMUNICATION FLOODED SECTION,” filed Apr. 19, 2010, incorporated fully herein by reference. Additionally, this application is related to U.S. Provisional Application Ser. No. 61/352,056, entitled “UNDERWATER ACOUSTIC MULTIPLE-INPUT/MULTIPLE-OUTPUT (MIMO) COMMUNICATION SYSTEMS AND METHODS,” filed Jun. 7, 2010, incorporated fully herein by reference.

### STATEMENT REGARDING FEDERALLY SPONSORED RESEARCH

The present invention was supported in part by Grant Number N00014-08-1-0756 from the Office of Naval Research. The United States Government may have certain rights to the invention.

### FIELD OF THE INVENTION

The present invention relates to the field of underwater communication and, more particularly, to apparatus, systems and methods for multiple-input/multiple-output (MIMO) communication in an underwater environment.

### BACKGROUND OF THE INVENTION

The oceans are becoming an increasingly important source of many human related needs, ranging from the study of biomedical organisms for combating disease to their potential role as a future energy resource. Scientific missions and civilian activities in the oceans are expanding, especially in coastal zones. These activities have led to an increasing demand on high speed underwater wireless telemetry and data communications among distributed sensors, autonomous underwater vehicles (AUVs), moored instruments, and surface ships.

Advances in digital signal communications, particularly in the last decade, have prompted new opportunities to advance science by providing a more detailed sampling of the ocean. Systems to transmit sound signals underwater for the purpose of communication including underwater modem technology have been developed and are being used with limited capability. While cellular communication in air utilizes radio frequency electromagnetic waves to transmit or broadcast information, sound waves are the primary carrier for transmission of communication signals in the underwater environment.

### SUMMARY OF THE INVENTION

The present invention is embodied in underwater multiple input/multiple output (MIMO) communication apparatus, systems, and methods. An exemplary underwater MIMO apparatus includes a submersible housing having a water impermeable section, a data acquisition system located within the water impermeable section of the submersible housing, and at least two transmission communication elements electrically connected to the data acquisition system. The MIMO communication apparatus may be used in a communication system including a communication array for communicating with the MIMO communication apparatus using a MIMO communication method.

### BRIEF DESCRIPTION OF THE DRAWINGS

The invention may be understood from the following detailed description when read in connection with the accompanying drawings. It is emphasized that, according to common practice, various features of the drawings may not be drawn to scale. On the contrary, the dimensions of the various features may be expanded or reduced for clarity. Moreover, in the drawings, common numerical references are used to represent like features. Included in the drawings are the following figures:

FIG. 1 is a side-view of an exemplary communication system in an underwater acoustic environment according to an embodiment of the present invention;

FIG. 2A is an illustrative diagram of a front portion of an underwater apparatus, including a nose cone and acoustically transparent section according to an embodiment of the present invention;

FIG. 2B is a cross-sectional view of the front portion of an underwater apparatus illustrating a first transducer arrangement according to an embodiment of the present invention;

FIG. 3 is a block diagram of data acquisition electronics for use with the communication system according to an embodiment of the present invention;

FIG. 4A is a cross-sectional view of a front portion of an underwater apparatus illustrating a second transducer arrangement according to an embodiment of the present invention;

FIG. 4B is a side-view of a front portion of an underwater apparatus illustrating a third transducer arrangement according to an embodiment of the present invention; and

FIG. 5 is a flow diagram of an underwater communication method in accordance with an embodiment of the present invention.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the disclosure without departing from the invention.

Conventional acoustic communication technologies typically use a single transmitter, which may have limited data rates due to the narrow bandwidth that is generally available in an underwater channel. The underwater channel may have extended multi-path spread, as well as rapidly changing characteristics (e.g., Doppler spread). The extensive, time-varying inter-symbol interference (ISI) that results from multi-path propagation is difficult to remove and, thus, seriously restricts achievable data rates.

The underwater environment is rich in spatial structure, as evidenced by the spatially dependent multi-path propagation. In general, with enough degrees of freedom in rich scattering environments, the channel capacity may increase with the number of transmitters and receivers. Therefore, multiple-input/multiple-output (MIMO) communication provides improved performance and increased capacity. A problem that arises in underwater acoustic MIMO communication, however, is co-channel interference (CoI) which results from the usage of multiple transmitters in addition to the ISI. Removal of both CoI and ISI is a challenging problem in an underwater channel.

Data rate increases can be achieved by simultaneously transmitting multiple data streams from a bank of transmitters. Taking advantage of the spatial difference of the signals from different transmitters, multiple data streams can be recovered at multiple receivers at the same time and at the same frequency. The transmission of multiple data streams provides increased data rates, similar to communicating through multiple, independent links between the sender and recipient. As a major technological driver, MIMO techniques are responsible for multi-fold data rate increases in radio frequency wireless communication.

In addition to the multipath effects, cross-talk among different transducers, also termed as co-channel interference, results from the usage of multiple transmitters in MIMO communication. Aspects of the present invention treat both multipath propagation and cross-talk in the dynamic ocean.

Conventional acoustic modem technology uses a single acoustic source and a receiver pair with limited bandwidth. The limitations of underwater channels can be prohibitive in high data rate transmissions. A mobile acoustic modem in accordance with an aspect of the present invention includes multiple transducers, multiple hydrophones, and a communication module. The communication module is able to use multiple transducers to send independent data streams through the ocean channel. It is also able to receive and decode the communication data using multiple hydrophones. A suitable communication algorithm and method for use in the mobile acoustic modem are specified in the related patent application entitled “UNDERWATER ACOUSTIC MULTIPLE-INPUT/MULTIPLE-OUTPUT (MIMO) COMMUNICATION SYSTEMS AND METHODS.”

One aspect of the invention relates to the MIMO technique applied to underwater apparatus to increase data rates and communication performance in the ocean. Particularly, for compact platforms, the present invention allows for cross-talk caused by the physical space constraint to be overcome on the receiver side. It is commonly believed that MIMO techniques cannot be applied to compact underwater platforms, however, the inventors have shown that MIMO is feasible for underwater communication through the use of cross-talk suppression techniques. Thus, the data rate of underwater communication systems as described herein on underwater apparatus, compact or large, can be increased.

Experimental results, discussed below, show that multiple transducers on the underwater apparatus can transmit independent data streams through the ocean channel. This is achieved through the suppression of the significant cross-talk. Thus, the MIMO technique can be applied to the compact (e.g., separation of the transducers by 3 meters or less, and more preferably 1 meter or less) underwater platform to improve the data rates and communication performance in the ocean. This is significant since up-to-date research efforts overwhelmingly rely on the physical source separation to use the MIMO transmission in the underwater environment. Typical physical source separation of 6-14 meters is required in the underwater environment.

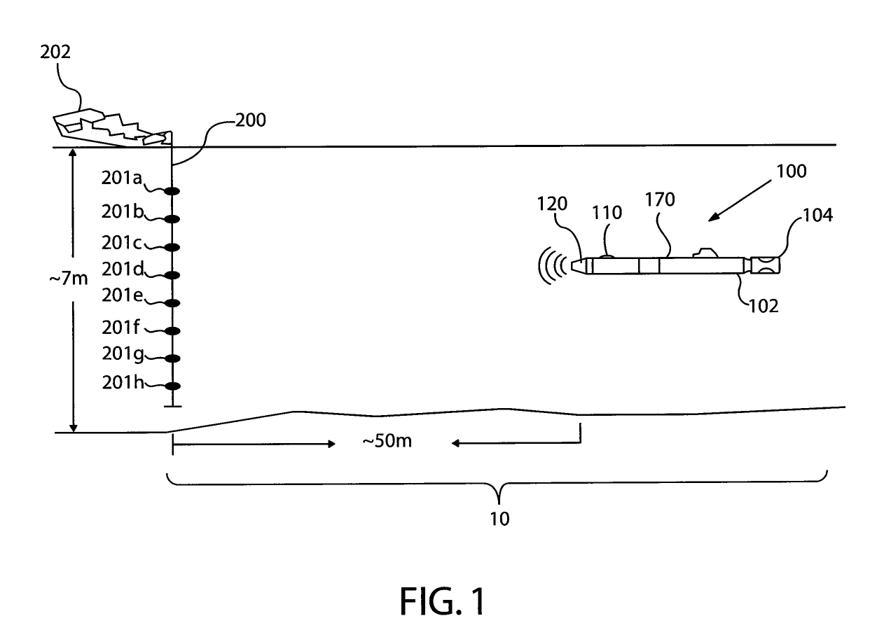

FIG. 1 depicts an underwater communication system 10. System 10 includes an underwater apparatus 100 and a remote communication array 200. Underwater apparatus 100 may communicate with a remote entity such as ship 202 via communication array 200. Communication array 200 includes multiple communication elements 201. In the illustrated embodiment, communication array 200 includes eight communication elements 201a-201h. The communication array 200 may be a receiving array (e.g., including hydrophone communication elements), a transmitting array (e.g., including transducer communication elements) or a multi-function array (e.g., including transducer and hydrophone communication elements) as needed for communication with the underwater apparatus 100. Suitable transducer and hydrophone communication elements for the communication array 200 will be understood by one of skill in the art from the description herein.

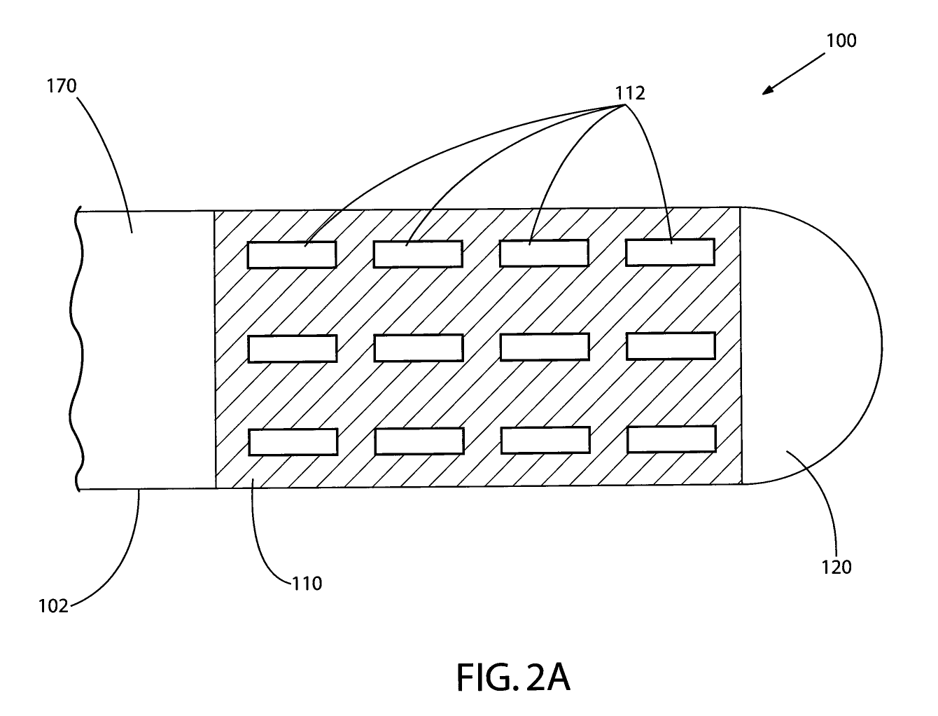

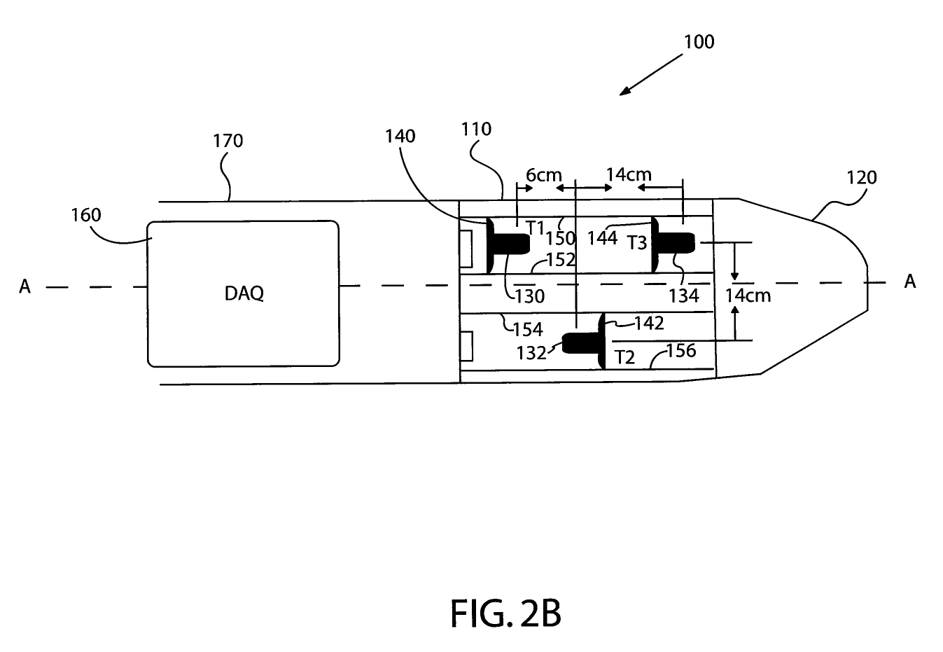

Underwater apparatus 100 includes a submersible housing 102. The illustrated submersible housing 102 includes a water impermeable section 170 and an acoustically transparent section 110. As shown in FIGS. 2A and 2B, a data acquisition system (DAQ) 160 is located in the water impermeable section 170 and at least two communication elements are located in the acoustically transparent section 110. The at least two communication elements may include at least two transmission communication elements (e.g., transducers) and, optionally, one or more receiving communication elements (e.g., hydrophones). Suitable communication elements for use in underwater apparatus 100 will be understood by one of skill in the art from the description herein. Acoustically transparent section 110 may be water permeable to permit flooding of this section.

A suitable submersible housing 102 is a Gavia AUV, which is a small, person-portable AUV manufactured by Teledyne-Gavia of Iceland. The Gavia AUV has an in-air weight of about 80 kg and a depth rating of 500 m. Navigation is accomplished via a high-precision Doppler-assisted Inertial Navigation System. The Gavia AUV consists of several separable modular sections. These modules can be assembled and locked together to form a single rigid 1 atmosphere pressure hull. A central power and communications backbone coupled through connectors on each module provides power, control signals, and communication data throughout the AUV. Each module is a stand-alone unit that can be operated outside of the AUV for charging, data access, development, and diagnostics. External access to the internal AUV network is provided by wireless local area network, global Iridium satellite link, and an acoustic, through-water, communication link. In addition, an Ethernet cable is provided for fast data access to the AUV units. Other suitable submersible housings will be understood by one of skill in the art from the description herein.

One of the modules of the Gavia AUV described above may be configured as an acoustically transparent section 110. Another module may be configured as the water impermeable section 170 housing the DAQ 160. As shown in FIG. 2A, acoustically transparent section 110 is located near a nose cone 120 of underwater apparatus 100. Acoustically transparent section 110 may be located essentially anywhere in the body of underwater apparatus 100, however, as shown in the drawings and described below, a suitable location for the acoustically transparent section 110 is near the nose cone 120 of the Gavia AUV. The acoustically transparent section is made from an acoustically transparent material that does not substantially block or alter the acoustic waves produced by transducers located within acoustically transparent section 110. The nose cone 120 may also be made of an acoustically transparent material.

The acoustically transparent section 110 depicted in FIG. 2A includes water inlets 112. Water inlets 112 allow for the water in which the underwater apparatus 100 is submerged to penetrate into the interior of the acoustically transparent section 110. The transducers propagate sound waves in the water that has flowed into the acoustically transparent section for receipt by the communication array 200. The DAQ 160 is capable of simultaneous transmission of multiple digital data streams using multiple transducers.

FIG. 2B shows a cross-sectional view of acoustically transparent section 110. As shown in FIG. 2B, multiple transducers 130, 132, 134 are placed within the acoustically transparent section 110. In one embodiment, the transducers 130, 132, 134 are BT-2RCL model transducers available from BTech Acoustics, LLC of Barrington, R.I. In one embodiment, transducers 130, 132, 134 are omnidirectional and therefore the orientation of the transducers is not important. Transducers 130, 132, 134 may be mounted onto mounting brackets 140, 142, 144. Mounting brackets 140, 142, 144 may, in turn, be mounted to support rods 150, 152, 154, 156. FIG. 2B depicts support rods 150, 152, 154, 156 parallel to the axis of the underwater apparatus 100 designated as dashed line A-A. It will be understood by one of skill in the art from the description herein, that support rods 150, 152, 154, 156 may be essentially any length needed for proper mounting of the transducers 130, 132, 134 and do not necessarily need to be oriented parallel to axis A-A.

In one embodiment, due to space constraints, physical separation among the source elements is limited. FIG. 2B shows the spatial relationship between transducers 130, 132, 134. As shown, only a couple of centimeters separate the 25 kHz transducers. Transducers 130 and 134 are mounted to mounting brackets 140 and 144, respectively. Mounting brackets 140 and 144 are mounted to support rods 150 and 152. Transducer 132 is mounted to mounting bracket 142. Mounting bracket 142 is mounted to support rods 154, 156. As shown in FIG. 2B, transducers 130, 132, 134 are placed in a nonlinear arrangement to maximize the communication element spacing. The minimum communication element separation (center-to-center distance) is about 6 cm in the horizontal direction and 14 cm in the vertical direction. It will be understood to one of skill in the art from the description herein, that transducers 130, 132, 134 and mounting brackets 140, 142, 144 may be mounted to support bars 150, 152, 154, 156 in essentially any configuration as needed by either the application of the communication system or by space concerns. Additional configurations of the transducers 130, 132, 134 and mounting brackets 140, 142, 144 are discussed below.

The modular structure of the Gavia AUV provides a convenient design environment for the acoustically transparent section 110. The multiple transducers 130, 132, 134 and the optional hydrophone array (not pictured) may be connected to a data acquisition system (DAQ) 160. The DAQ electronics 160 are housed within the water impermeable section 170. In the Gavia-AUV, the water impermeable section 170 measures 40 cm in length and 20 cm in outer diameter and may be located towards the rear of the AUV.

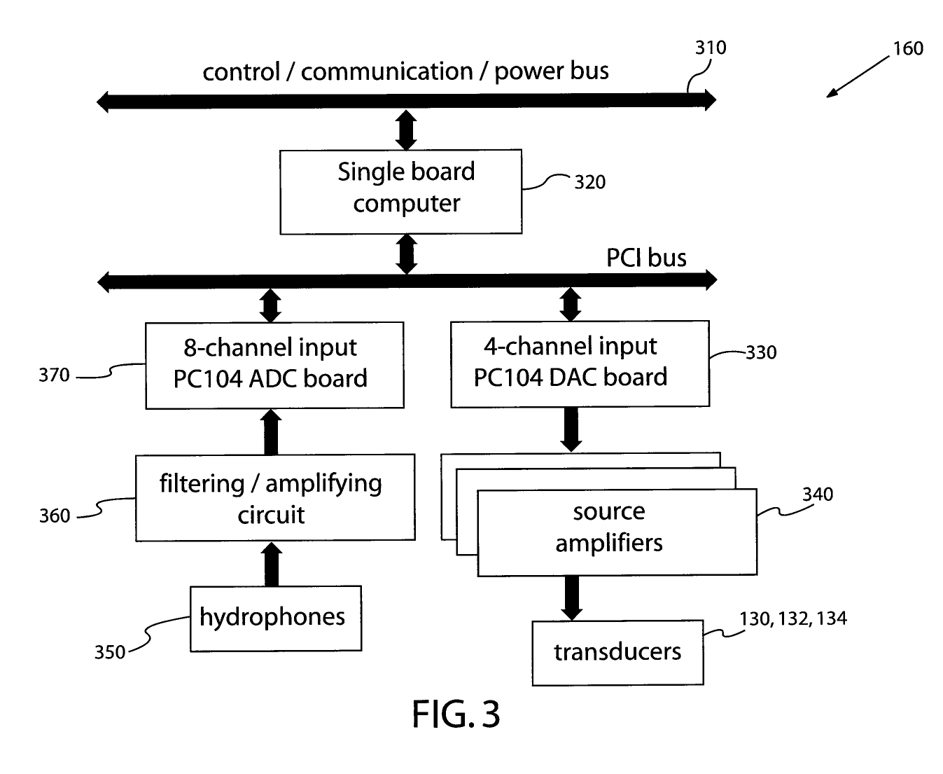

A description of the operation of the transducers 130, 132, 134 follows. FIG. 3 shows a block diagram of the DAQ 160. The vehicle bus 310 provides power, overall control, and communication to the DAQ 160. The DAQ electronics 160 may be built using a standard PC104plus bus single board computer available from VersaLogic Corp. of Eugene, Oreg. Based on stored instructions, a single board computer 320 can feed three data streams of information to an output digital-to-analog converter (DAC) board 330 to control and to interface with the vehicle bus 310. Then the analog electronic signals from DAC board 330 are amplified by source amplifiers 340 and channeled to the three transducers 130, 132, 134. Housed in an acoustically transparent section 110, the transducers 130, 132, 134 then emit the acoustic signals into the water. In one embodiment, the center frequency of three identical transducers 130, 132, 134 is about 25 kHz. In one embodiment the DAQ 160 is a modulator/demodulator (MODEM). Suitable MODEMs for use as DAQ 160 will be understood by one of skill in the art from the description here.

The DAQ 160 can also record acoustic signals and store digitized samples. If equipped with hydrophones 350, the DAQ 160 may use a filtering/amplifying circuit 360 to filter and amplify the acoustic signals acquired by the hydrophones 350. The conditioned signals are fed to an analog-to-digital converter (ADC) board 370 for digitization. In a final stage, the digital samples are stored on a hard drive (not shown). A hydrophone array 350 may be pulled by the underwater apparatus 100 or, in another embodiment, the hydrophone array 350 may be placed on an external surface of the underwater apparatus 100. Suitable hydrophones and their arrangement will be understood by one of skill in the art from the description herein.

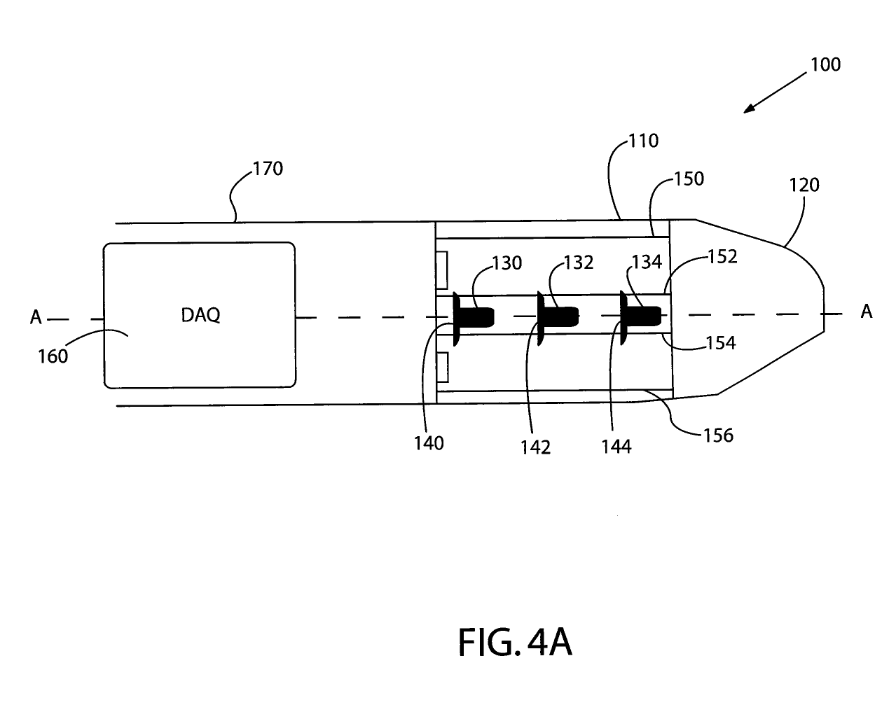

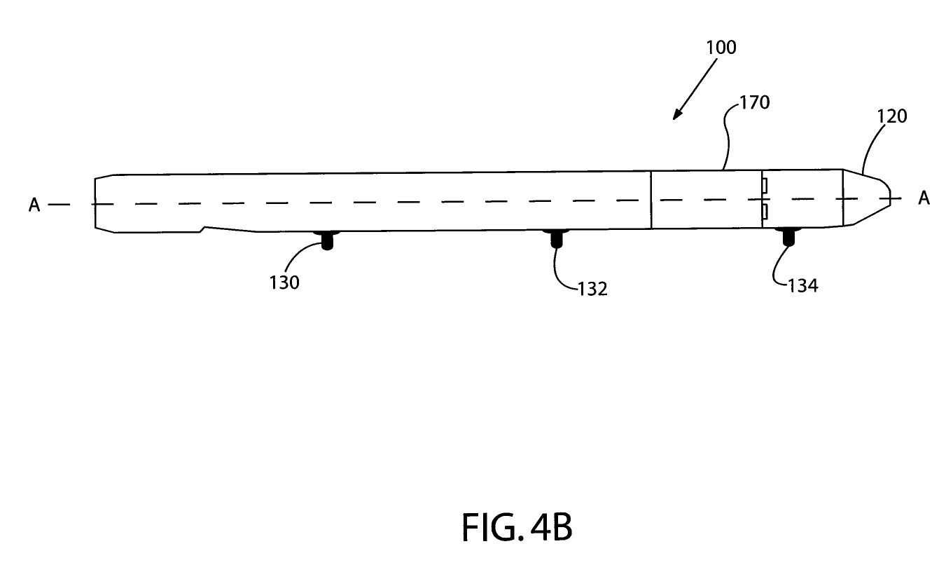

As shown in FIG. 4A, in an alternative embodiment, transducers 130, 132, 134 may be placed in a linear formation as limited by space constraints or desired for operation. The placement and location of transducers 130, 132, 134 is dependent upon the specifics of the underwater apparatus 100. Generally, a wider separation may improve communication performance if space is available on/within the underwater apparatus 100. In yet another embodiment, transducers 130, 132, 143 may be placed on an external surface of the underwater apparatus 100. An example of this configuration is shown in FIG. 4B. It will be understood by one of skill in the art that the acoustically transparent section 110 may be omitted if transducers are placed on an external surface of the underwater apparatus 100.

The water impermeable section 170, acoustically transparent section 110, and nose cone 120 were purchased from the AUV manufacturer, Teledyne-Gavia. The acoustically transparent section 110 allows transducers 130, 132, 134 to soak in seawater during underwater apparatus operations. The transducers 130, 132, 134 should be in water for heat dissipation. The acoustically transparent section 110 and the nose cone 120 are made of acoustically transparent material, having similar water resistance as well as matching density and sound speed with seawater. Acoustically transparent material was used in order to not block acoustic transmissions. In one embodiment, the DAC board 330 can handle four data streams. In the embodiments described above, only three transducers and their amplifiers are discussed due to the size and power constraints. One of skill in the art should understand that two or more than three transducers may also be used, and this description is not intended to limit the invention to a specified number of transducers.

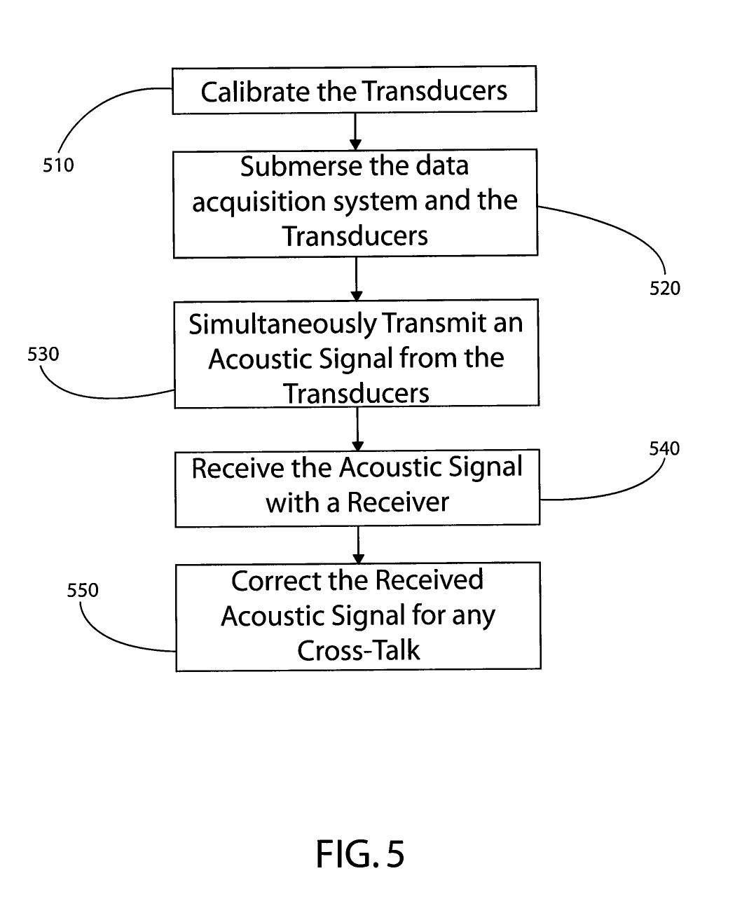

Another aspect of the present invention relates to a method for communicating underwater with a MIMO system. FIG. 5 is a flow chart of exemplary underwater MIMO communication steps. As shown, a first step (step 510) for the underwater communication includes calibrating communication elements (transducers and/or hydrophones) that are being used in the underwater apparatus 100 or communication array 200. The underwater apparatus 100 and communication array 200 including the transducers and hydrophones may be tested in an acoustic tank facility such as the acoustic tank facility at the University of New Hampshire located in Durham, N.H. Acoustic source level and reception sensitivity of the hydrophone array can be measured using standard acoustic calibration routines known to one of skill in art.

The underwater apparatus 100 is submersed into a body of water in step 520. As discussed above, the underwater apparatus 100 may, in some embodiments, be equipped with transducers and optional hydrophones and the communication array 200 may include hydrophones and/or transducers.

At step 530, a signal is acoustically transmitted (e.g., simultaneously) by at least two communication elements. The transmitted acoustic signal may comprise multiple packets of data generated by transducers 130, 132, 134 at the same time. The transmitted acoustic signal propagates through the water for reception by a communication array such as communication array 200.

The transmitted acoustic signal is received by the communication array 200 in step 540. The communication array 200 may receive the transmitted acoustic signal via hydrophones. Finally, after the transmitted acoustic signal is received by the communication array 200, the signal is processed and corrected for any cross-talk in step 550. This process may also optionally include amplification of the signal as needed. A suitable cross-talk correcting algorithm is described in the related patent application entitled “UNDERWATER ACOUSTIC MULTIPLE-INPUT/MULTIPLE-OUTPUT (MIMO) COMMUNICATION SYSTEMS AND METHODS.”

The underwater apparatus 100 is not limited to an AUV. Rather, underwater apparatus 100 may be essentially any object that is used underwater, such as a remote operated vehicle (ROV), a manned submersible, a moored instrument or other underwater apparatus. Furthermore, the communication array 200 may be used by any submersed object such as an AUV, ROV, moored instrument, manned submersibles or any other underwater apparatus.

One of skill in the art will also understand from the description herein that the underwater communication will not be limited by the description above, and may include two-way communications between the underwater apparatus 100 and the communication array 200. The underwater communications may also be sent from a communication array 200 to an underwater apparatus 100 or both the communication array 200 and the underwater apparatus 100 may send and receive underwater communications back and forth.

### EXPERIMENTAL RESULTS

Field tests were conducted to examine the acoustic transmissions as well as the AUV navigation with the acoustically transparent section 110 in the Delaware Bay. The acquired acoustic communication data were processed by advanced signal processing techniques, which address both the cross-talk and multipath effects. MIMO communication through two transducers was demonstrated at the AUV.

The Gavia AUV with a MIMO acoustically transparent section 110 was deployed twice in the Delaware Bay. The experimental site was the northwest corner of the Bay mouth. The water depth was about 7 m. The first stage was to examine the navigation behavior of the AUV with the acoustically transparent section 110 filled with water. The vehicle was deployed from a small research vessel. The AUV showed slight altered behaviors when diving. This was due to the increased vehicle length and altered mass. The AUV did manage navigation at the planned depth, however. The AUV also successfully followed the mission plans. After multiple navigation missions, acoustic transmissions were performed. The communication transmissions were centered at 25 kHz using binary phase-shift keying signaling. The symbol rate was 2 kHz and the bandwidth utilized was 3 kHz. An 8-element hydrophone array was lowered from the R/V Donna M to record the MIMO transmissions from the AUV. The recorded communication data were processed using the communication algorithm developed and discussed in the related patent application entitled “UNDERWATER ACOUSTIC MULTIPLE-INPUT/MULTIPLE-OUTPUT (MIMO) COMMUNICATION SYSTEMS AND METHODS.”

To deal with the propagation multipath, time reversal processing specifically designed for high frequency acoustic communication was used. An interference cancellation scheme was used to suppress the cross-talk in the underwater MIMO system. The communication algorithm iterated the time reversal processing and cross-talk suppression for optimized performance. The communication data analysis showed that significant cross-talk existed due to the closely located transducers for the two-transducer transmissions at the communication range of about 50 m. With the aid of signal processing techniques, the two data streams were successfully separated. Both data streams were recovered at reasonably good performance (low bit-error-rate) at the hydrophone array. Each data stream corresponded to communication at the data rate of 2 kilobits/s. Therefore, the overall data rate was doubled to 4 kilobits/s when using two transducers. The spectral efficiency also doubled as a result of MIMO transmissions.

A wider bandwidth and more communication elements may be employed to extend ranges and data rates, e.g., to over 10 kilobits/s.

While preferred embodiments of the invention have been shown and described herein, it will be understood that such embodiments are provided by way of example only. Numerous variations, changes and substitutions will occur to those skilled in the art from the description herein without departing from the spirit of the invention. Accordingly, it is intended that the appended claims cover all such variations as fall within the spirit and scope of the invention.

What is claimed:

1. An underwater multiple input/multiple output communication apparatus, the apparatus comprising:
a submersible housing having a water impermeable section;
a data acquisition system located within the water impermeable section of the submersible housing; and
at least two transmission communication elements electrically connected to the data acquisition system.

2. The apparatus of claim 1, wherein the submersible housing further comprises an acoustically transparent section and the at least two transmission communication elements are located within the acoustically transparent section.

3. The apparatus of claim 2, wherein the acoustically transparent section is water permeable.

4. The apparatus of claim 2, wherein the submersible housing comprises a first axis and the at least two transmission communication elements are located on a second axis substantially parallel to the first axis.

5. The apparatus of claim 2, wherein the submersible housing comprises a first axis and each of the at least two transmission communication elements are located on a respective different axis parallel to the first axis.

6. The apparatus of claim 1, wherein the at least two transmission communication elements are located on an exterior surface of the submersible housing.

7. The apparatus of claim 1, further comprising at least one amplifier electrically coupled to the data acquisition system and at least one of the at least two transmission communication elements.

8. The apparatus of claim 1, further comprising at least one hydrophone electrically coupled to the data acquisition system.

9. The apparatus of claim 1, wherein the data acquisition system further comprises a processor.

10. The apparatus of claim 1, further comprising a power source electrically connected via a vehicle bus to the data acquisition system and the at least two transmission communication elements.

11. The apparatus of claim 1, wherein the submersible housing is an autonomous underwater vehicle.

12. The apparatus of claim 1, wherein the at least two transmission communication elements are separated from one another by less than 1 meter.

13. The apparatus of claim 1, wherein the data acquisition system comprises a modem.

14. An underwater communication system comprising:
the apparatus of claim 1; and
a communication array including at least two receiving communication elements located underwater.

15. A method for communicating underwater, wherein the method comprises:
submersing the apparatus of claim 1;
transmitting an acoustic signal from the submersed apparatus;
receiving the transmitted acoustic signal with at least one receiver; and
correcting cross-talk in the received acoustic signal.

16. The method of claim 15, wherein the acoustic signal is transmitted simultaneously by the at least two transmission communication elements;

17. The method of claim 15, further comprising calibrating the at least two transmission communication elements to reduce noise and cross-talk before the apparatus of claim 1 is submersed.
